(19) United States
(12) Patent Application Publication
(10) Pub. No.: US 2015/0156285 A1
(43) Pub. Date: Jun. 4, 2015

(54) MESSAGE TUNNELING IN INDUSTRIAL NETWORKS

(71) Applicant: Richard Blair, Plaistow, NH (US)

(72) Inventor: Richard Blair, Plaistow, NH (US)

(73) Assignee: SCHNEIDER ELECTRIC INDUSTRIES SAS, Rueil Malmaison (FR)

(21) Appl. No.: 14/406,060

(22) PCT Filed: Jun. 7, 2012
(86) PCT No.: PCT/US2012/041338

§ 371 Date: Dec. 5, 2014

(51) Int. Cl. H04L 29/06; H04L 29/08

(52) U.S. Cl. CPC H04L 69/18; H04L 67/02

(57) ABSTRACT

A networking system is discussed. The system may be used for industrial networks where access to field device data is valuable. Commands, such as read or write requests to particular field device data, may be encapsulated within messages conforming to an object-oriented protocol, such as, for example, Common Industrial Protocol (CIP). Responses to the commands may also be encapsulated within CIP messages. The encapsulated commands and responses may be transmitted between various devices of an industrial network, including a controller and a gateway device, such as a multiplexer, of the industrial network. Encapsulating the commands and responses may provide a tunneling mechanism allowing a controller complete access to the data of the field devices in communication with the gateway device.

### CROSS REFERENCE TO RELATED APPLICATIONS

This application is related by subject matter to the following applications: PCT application number ______ (also identified by attorney docket number 500402.00594); PCT application number ______ (also identified by attorney docket number 500402.00595); and PCT application number (also identified by attorney docket number 500402.00596). All of the above-mentioned patent applications are herein incorporated by reference and are being filed concurrently with the present application.

### BACKGROUND

Devices connected to an industrial network, such as a network with devices used in automation control or some other type of process control, may use various protocols to communicate with each other. Using specific communication protocols may allow access to particular data throughout the network, but may also cause other data to be inaccessible to some devices. For example, some widespread communications protocols, such as Ethernet Industrial Protocol (EtherNet/IP), cannot provide a controller of the industrial network with complete access to the data of some types of field devices. Providing a controller complete access to the data of a field device may allow for increased controller functionality in an industrial network, which can improve automation and process control. Consequently, there is a need to improve the access a controller has to the data of the field devices.

### SUMMARY

Some aspects of the disclosure relate to methods for tunneling or encapsulating various messages using Common Industrial Protocol (CIP), which was previously known as Control and Information Protocol.

In some variations, systems and methods described herein may include aspects related to a controller of an industrial network, a gateway device of the industrial network, and one or more field devices of the industrial network.

In some embodiments, the gateway device may be configured to receive, from the controller, a message that encapsulates a command conforming to a protocol for communicating with a field device, such as, for example, a Highway Addressable Remote Transducer (HART) command. The gateway device may also extract the command from the message and transmit the command to one or more field devices. The gateway device may further receive data responsive to the command from the one or more field devices, encapsulate the data in a message (e.g., HART response), and transmit the message that encapsulates the data to the controller.

Additionally, in some arrangements, the controller may be configured to create a command, such as a HART command that requests an ID number or product code from the one or more field devices. The controller may encapsulate the command in a message and transmit the message to a gateway device. The controller may further receive a response message from the gateway device that encapsulates data responsive to the command, extract the data from the received response message, and subject the data to further processing. For example, in instances where the data includes an ID number or a product code of a field device, the controller may verify that the ID number or product code matches an expected value.

The preceding presents a simplified summary in order to provide a basic understanding of some aspects of the disclosure. The summary is not an extensive overview of the disclosure. It is intended neither to identify key or critical elements of the disclosure nor to delineate the scope of the disclosure. The summary merely presents some concepts of the disclosure in a simplified form as a prelude to the description below.

### BRIEF DESCRIPTION OF THE DRAWINGS

The present disclosure is illustrated by way of example and is not limited in the accompanying figures.

FIG. 1 illustrates an example of an industrial network, in accordance with various aspects of the disclosure.

FIG. 2 illustrates an example computing device on which various methods of the disclosure may be implemented, in accordance with various aspects of the disclosure.

FIG. 3 illustrates an example data model for network communications, in accordance with various aspects of the disclosure.

FIG. 4A provides an example method for transmitting encapsulated HART commands using CIP, in accordance with various aspects of the disclosure.

FIG. 4B provides an example method for processing CIP messages and transmitting encapsulated HART responses using CIP, in accordance with various aspects of the disclosure.

FIG. 4C provides an example method for receiving encapsulated HART responses using CIP, in accordance with various aspects of the disclosure.

FIG. 5 illustrates an example data format that may be used for encapsulating HART commands and HART responses using CIP, in accordance with various aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

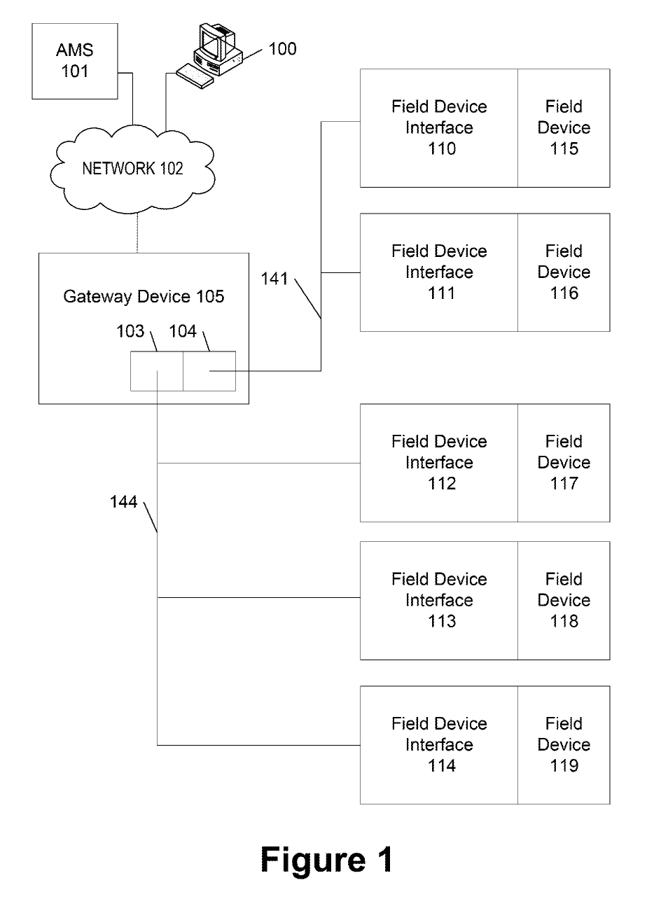

FIG. 1 illustrates an example of an industrial network. Such a network may be used, for example, to control, monitor or regulate various industrial processes such as, for example, an amount of fluid that is allowed into a mixing device using various sensors and actuators. It is to be understood that industrial networks may be made up of a number of other devices, that industrial networks may have different network configurations, and that industrial networks may serve different purposes. The network shown in FIG. 1 is merely an example.

In this example, a controller 100, such as, for example, a programmable logic controller (PLC), personal computer, distributed control system, remote terminal unit, or human-machine interface (HMI) device, may be connected to a gateway device 105, such as, for example, a multiplexer or switch, via a network 102.

Gateway device 105 may also be connected to one or more field devices, such as field devices 115-119. Gateway device 105 may include one or more modems, such as modem 103 and modem 104 (e.g., a frequency shift keying modem), to facilitate communication to and from the field devices 115-119. Gateway device 105 may also include one or more universal asynchronous receiver/transmitters (UART), such as, for example, one UART for each modem. Gateway device 105 may also include one or more processors, and memory. In some embodiments, the connections to the field devices (depicted as connection 144 and 141 in FIG. 1) may be wired (e.g., via two-wire connections, four wire connections, twisted pair wires, transmission lines suitable for 4-20 milliamp instruments, Ethernet cables, or other cable type), wireless (e.g., IEEE 802.11b, or the like), or a combination thereof. Network 102 may also include wired connections, wireless connections, or a combination thereof. In some arrangements, connection 144 may be a first current loop and connection 141 may be a second current loop. In some variations, connection 144 and/or connection 141 may be a collection of wires so that each field device has its own wire directly connecting the field device to a modem of the gateway device. In embodiments similar to that illustrated in FIG. 1, controller 100 may transmit and receive data (e.g., messages or requests) to/from gateway device 105. Gateway device 105 may transmit and receive data (e.g., messages or requests) to/from field devices 115-119.

Asset management software (AMS) 101 may be connected to the gateway device 105. The asset management software may run on any computing device. Asset management software is typically used to monitor the status of an industrial network. This often involves repeatedly checking the status of various sensors, valves, or other field devices. Gateway device 105 may help facilitate these checks by retrieving data from field devices automatically on an ongoing basis. By automatically retrieving data from field devices on an ongoing basis (which is sometimes referred to as “scanning”), the gateway device may improve the speed with which it can provide data to the asset management software.

Many industrial processes rely on inputs being processed and converted to outputs in a deterministic fashion. For example, the process controlling the devices of FIG. 1 may rely on the readings detected by a sensor (e.g., field device 115) and causing a valve (e.g., field device 116) to be adjusted within a threshold time (e.g., 250 milliseconds) of the readings under normal operating conditions. This threshold time limit is an example of an application response time (ART). One aspect of achieving an ART limit is using a controller, such as controller 100 that processes inputs, produces outputs based on those inputs within a predetermined amount of time, and transmits the outputs to gateway device 105 for distribution to the appropriate field device(s) of the industrial network.

Field devices 115-119 may include field device interfaces 110-114, to facilitate the connections to the gateway device 105. Field device interfaces 110-114 may each include a communication module. The communication module may depend on the network type. For example, in some network embodiments, the communication module may be a modem, such as an integrated frequency shift keying modem. Field device interfaces 110-114 may also each include a processor, memory, transmitter, receiver, or other suitable electrical circuitry component. A field device's interface (depicted as field device interfaces 110-114) may be integral with or separate from the field device itself. For example, a field device's interface may be a separate module that connects to the field device using, for example, a group of wires.

Field devices 115-119 may be of various types, such as sensors, transmitters, actuators, or any other device that may be used in an industrial network (e.g., a network for controlling or monitoring an industrial process). In some arrangements, field devices 115-119 may be individually addressable and gateway device 105 may store the information needed to send and receive data directly to/from any of the field devices 115-119. In some arrangements, gateway device 105 and field devices 115-119 may communicate with each other using a Highway Addressable Remote Transducer (HART) protocol, provided by the HART Communication Foundation (HCF), or some variant of the HART protocol. Other protocols may be used by the field devices 115-119 to communicate. Accordingly, in some variations, the modems included in the gateway device 105 and field devices 115-119 may be HART modems. In general, the HART protocol may be considered a master-slave protocol (interchangeably referred to as a client-server protocol) where HART data is superimposed on an analog signal (e.g., a 4 to 20 milliamp signal). In some embodiments, the gateway device 105 may be considered the “master” HART device, and each of the field devices 115-119 may be considered the “slave” HART devices. Although five field devices are shown in FIG. 1, an industrial network may contain any number or type of field device(s). The HART protocol may also be considered a protocol for communicating with field devices (e.g., field devices 115-119).

The HART protocol may include different operational modes, such as a point-to-point mode, where digital signals are superimposed on an analog signal. In a point-to-point mode, both the digital signal and the analog signal carry information to/from a HART field device. Another example of an operational mode is the multidrop mode where digital signals are superimposed onto a constant analog signal and only the digital signal carries information to/from a HART field device. In the multidrop mode, the digital signal may comprise a packet (e.g., a HART packet) and the packet may include an address that identifies a particular one of the HART field devices to which the packet is being directed (or from which the packet is being sent). A HART field device may monitor the digital signal until a packet matching its address is identified.

A HART packet may be structured as follows: a preamble field (length of 5-20 bytes) for synchronization and carrier detection; a start byte field (length of 1 byte) that specifies the master number; an address field (length of 1 or 5 bytes) that specifies a device address; a command field (length of 1 byte) that specifies a numerical value for the command to be executed; a number of data bytes field (length of 1 byte) that indicates the size of the data field; a status field (length of 0-2 bytes) for execution and health reply (in some arrangements, a status field may only be included in HART responses); a data field (length of 0-253 bytes) for data associated with the command; and a checksum field (length of 1 byte) for error detection.

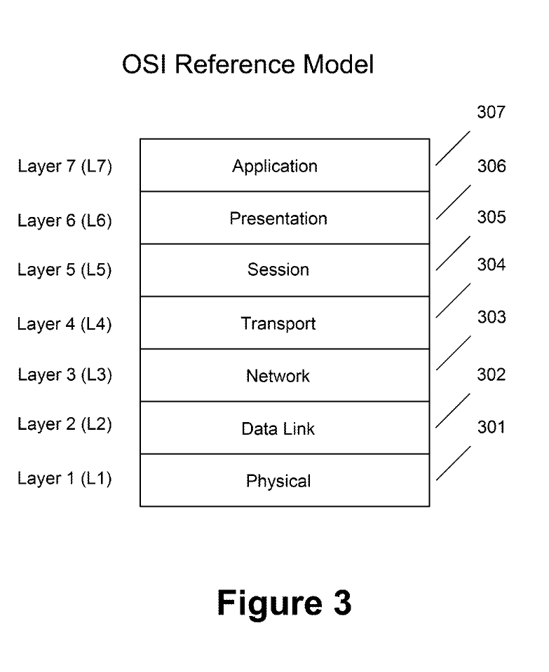

In some arrangements, communication between controller 100 and gateway device 105 may utilize a protocol different from the protocol used between the gateway device 105 and the field devices 115-119. For example, communication between controller 100 and gateway device 105 may be based on CIP, supported by the Open DeviceNet Vendors Association, or some variant of CIP. CIP may provide a communication architecture that can be used in various network implementations, such as EtherNet/IP, DeviceNet, CompNet and ControlNet. Accordingly, features of CIP may be found at various layers of the Open Systems Interconnection (OSI) Reference Model, which, for example, provides for a layered communication architecture. FIG. 3 illustrates one representation of an OSI Reference Model, which includes physical layer 301, data link layer 302, network layer 303, transport layer 304, session layer 305, presentation layer 306 and application layer 307.

CIP may be considered an object-oriented protocol. A CIP object may include attributes, services or commands, connections, and behaviors. A CIP object may behave identically from device to device, and a collection of CIP objects on a device may be referred to as a device profile. A device profile may specify the configuration options and I/O data formats available to a device. Thus, two or more devices that implement the same device profile can respond identically to the same set of commands and exhibit identical network behavior.

CIP objects may be structured into classes, instances and attributes. A class may be a set of objects that represent the same kind of system component. An instance may the representation of a particular object within a class, and each instance of a class may have a set of attributes. Some of the attributes may be common to the class, while other attributes may be specific to the instance itself. The class, instance, and attribute(s) for a CIP object may be defined in the CIP object by various identifiers. For example, a class identifier (e.g., with an integer value) may be used to identify the class of the CIP object. An instance identifier (e.g., with an integer value) may be used to identify the instance of the CIP object. One or more attribute identifiers (e.g., with an integer value) may be used to identify the various attribute(s) of the CIP object.

CIP objects may also be associated with a particular device on a network. In some arrangements, this association is accomplished by including an address identifier in the CIP object. In some implementations, such as those utilizing DeviceNet and ControlNet, a device's Media Access Control Identifier (MAC ID) may be used as the value of the address identifier. In others, such as those utilizing EtherNet/IP, the address identifier's value may be the IP address of the associated device.

Various service codes may also be defined in connection with a CIP object and may be used by devices to provide various data services. A service code may identify an action request that can be directed at a particular CIP object instance or object class. When invoking an action via a service code, a message may be transmitted that includes a service code, information identifying the object the message is directed to, and additional data (if any).

In addition to CIP and HART, devices of an industrial network may utilize various types of communication protocols. For example, devices may communicate using DeviceNet, CompNet, ControlNet, ProfiNet, and the like.

Although FIG. 1 is illustrated with only one controller 100 and one gateway device 105, an industrial network may include several computers similar to controller 100 and/or several gateway devices. If the several computers communicate with one another across a network in order to produce an output, the output may be communicated to one or more of the several gateway devices for transmission to one or more of the field devices. Additional alterations may also be made to the industrial network illustrated in FIG. 1. For example, controller 100 may be modified to include gateway device 105 as one of its components. If gateway device 105 is incorporated into controller 100, controller 100 may still include an Ethernet port for communications with other outside devices, other controllers, and other computing devices.

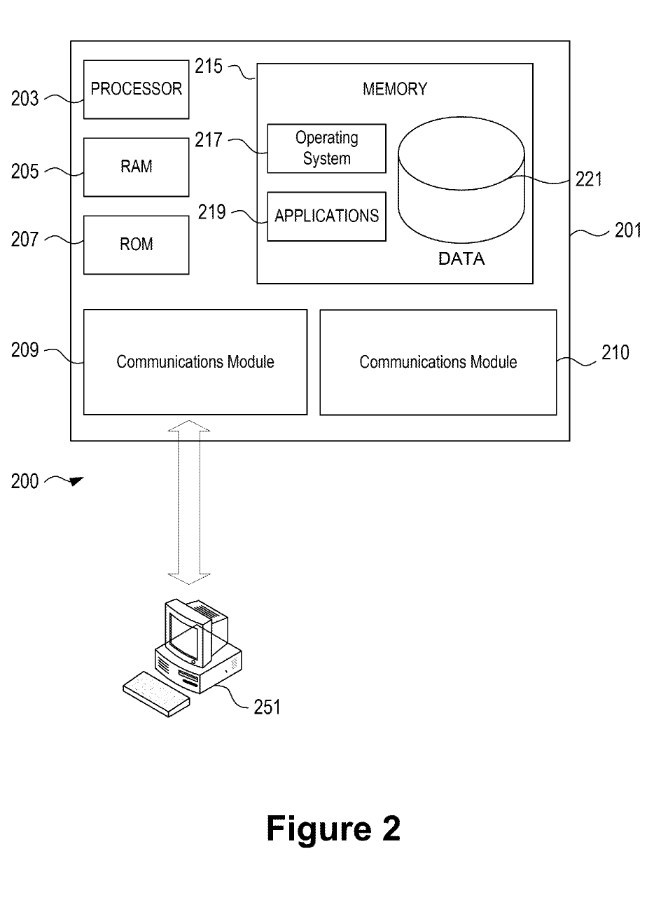

With reference to FIG. 2, the computing system environment 200 may include a computing device 201 wherein various aspects discussed herein may be implemented. Computing device 201 provides an example of general hardware and software elements that may be used to implement any of the various devices discussed herein, such as gateway devices, multiplexers, field devices, field device interfaces, switches, controllers and the like. Computing device 201 may include one or more processors 203, which may execute instructions to perform any of the features described herein. The one or more processors 203 may control overall operation of the computing device 201 and its associated components, including random-access memory (RAM) 205, read-only memory (ROM) 207, one or more communications modules (e.g., communication module 209 and communications module 210), and memory 215. Structures such as FPGAs (field programmable gate arrays) and/or ASICs (application-specific integrated circuits) may also be used.

Computing device 201 may include a variety or combination of computer-readable media, storage media, and/or communication media. Computer-readable media include any available media that can be accessed by computing device 201. By way of example, and not limitation, computer-readable media may comprise a combination of computer storage media and communication media. Storage media include volatile and nonvolatile, removable and non-removable media implemented in any method or technology for storage of information such as computer-readable instructions, object code, data structures, program modules, or other data.

Communication media may embody computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a direct-wired connection (e.g., Ethernet, etc.), and wireless media such as acoustic, RF, infrared and other wireless media.

Communications module 209 may include a microphone, keypad, touch screen, and/or stylus through which a user of computing device 201 may provide input, and may also include one or more of a speaker for providing audio output and a video display device for providing textual, audiovisual and/or graphical output. Communication module 209 may also support a direct-wired and/or wireless connection for communicating with another device.

Software may be stored within memory 215 and/or other storage media to provide instructions to processor(s) 203 for enabling computing device 201 to perform various functions. For example, memory 215 may store software used by the computing device 201, such as an operating system 217, application programs 219, and a database 221. Also, some or all of the computer executable instructions for computing device 201 may be embodied in hardware or firmware. Computer readable instructions may be stored in a ROM, RAM, removable media, such as a Universal Serial Bus (USB) drive, compact disk (CD) or digital versatile disk (DVD), floppy disk drive, or any other desired electronic storage medium. Instructions may also be stored in an attached (or internal) hard drive.

Additionally, one or more application programs 219 used by the computing device 201, according to an illustrative embodiment, may include computer executable instructions for invoking user functionality related to communication including voice input and speech recognition applications (e.g., for transmitting/receiving EtherNet/IP messages, etc.).

Computing device 201 may support a point-to-point connection to a computing device 251 (e.g., a field device within an industrial network, a PLC, controller, etc.). The computing device 251 may be a computing device that includes many or all of the elements described above relative to the computing device 201. While FIG. 2 illustrates communication module 209 as being in communication with computing device 251, communications module 210 may be in communication with a similar computer device.

Although not required, various aspects described herein may be embodied as a method, a data processing system, or as a computer-readable medium storing computer-executable instructions. For example, aspects of the method steps disclosed herein may be executed by processor(s) 203 or instructions stored on computer-readable media may be configured to cause processor(s) 203 to perform steps of a method in accordance with aspects of the disclosure. As another example, one or more aspects of the disclosure may be embodied in computer-usable or readable data and/or executable instructions, such as in one or more program modules, executed by one or more processors or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-readable instructions may be stored on a computer readable medium, as described above. The functionality of the program modules may be combined or distributed as desired in various illustrative embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of executable instructions and computer-usable data described herein.

The steps that follow in the Figures may be implemented by one or more of the components in FIGS. 1 and 2 and/or other components, including other computing devices.

As discussed above, a gateway device (e.g., gateway device 105), such as a multiplexer in an industrial network, may communicate with another computer (e.g., controller 100), such as a PLC in the industrial network, using CIP or some other suitable object-oriented protocol. The gateway device may also communicate with the various field devices (e.g., field devices 115-119), such as the sensors, switches, and actuators of the industrial network, using the HART protocol.

To allow complete control and/or monitoring of the HART field devices, the CIP communication between the gateway device and the computer may include encapsulated HART messages (also referred to as tunneling of HART messages over CIP). HART messages may be of various types, including HART commands, HART responses, and HART error responses. Such encapsulation may allow for all of the HART data of a field device (e.g., data that is located at the gateway device or the field device) to be accessible to the computer. For example, in some variations, a controller and a gateway device may support the exchange of HART process variables over CIP. The exchange of HART process variables over CIP may also be supported by a human-machine interface (HMI) and a gateway device, or a supervisory control and data acquisition (SCADA) system and a gateway device. However, the controller (or other computer supporting the exchange) and the gateway device may not allow for the exchange of any other parameters present in the HART field devices, such as, for example, the exchange of a field device's manufacturer's ID number or product code, version, and tag name. By encapsulating HART messages within CIP messages, a gateway device and controller may allow complete read/write access to a HART field device's data, including process, configuration, diagnostic and variable data. Allowing complete access to a HART field device's data may allow for additional functionality to be implemented by a controller, such as, for example, verification that the correct field device is connected prior to using its data or dynamically tuning parameters (e.g., thresholds, scaling factors, etc.) depending on the process control.

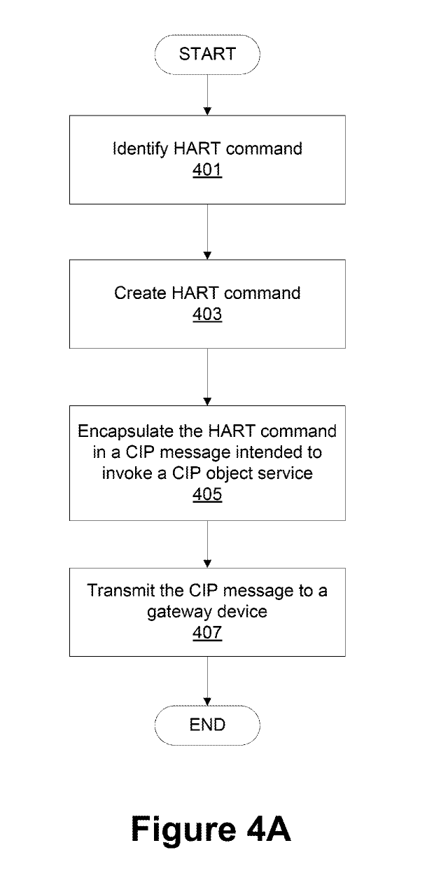

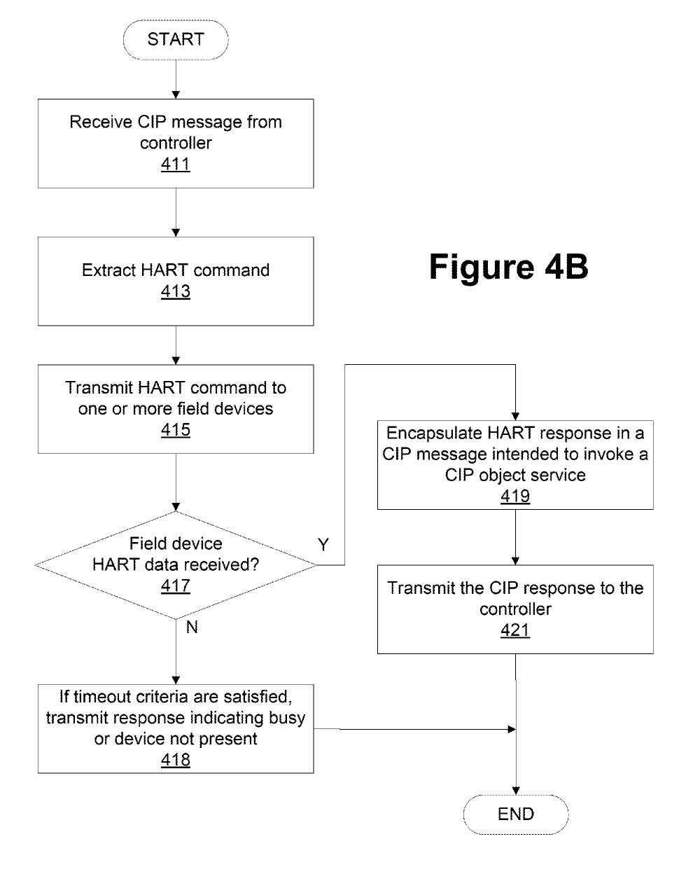

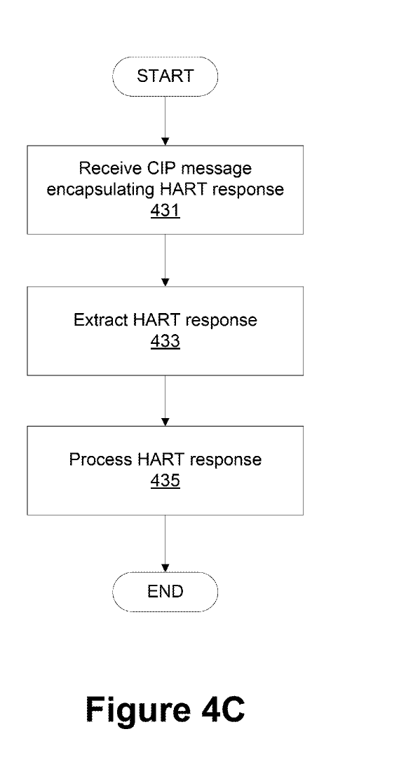

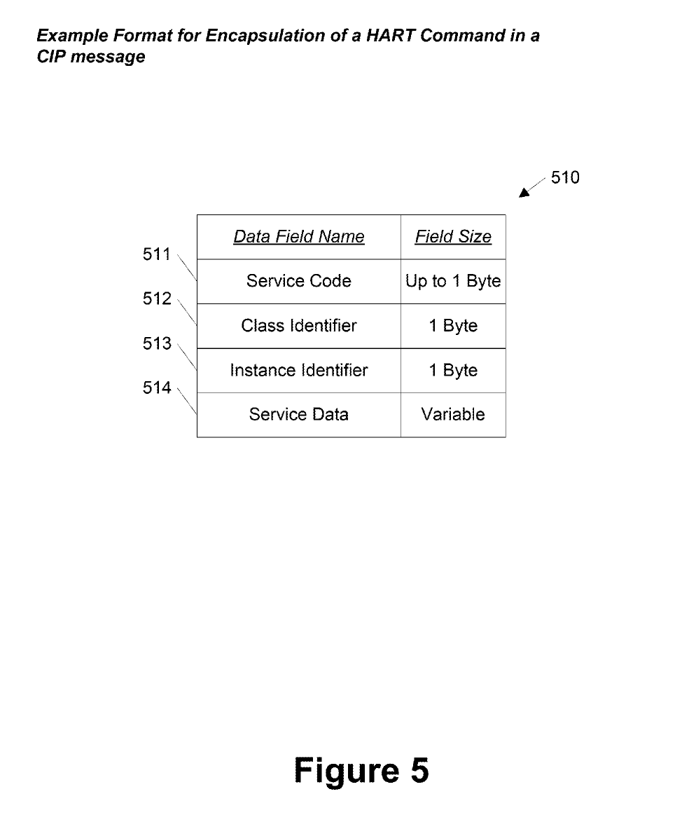

In some arrangements, a controller (e.g., controller 100) may be configured to transmit encapsulated HART commands to a gateway device, such as a multiplexer. FIG. 4A provides an example method for transmitting encapsulated HART messages using CIP. In some arrangements, other protocols instead of CIP may be used, including another object-oriented protocol. Additionally, other protocols instead of HART may be used, such as another protocol for communicating with a field device. Details of the example method of FIG. 4A will be discussed in connection with the example data formats of FIG. 5. Although the example method of FIG. 4A is discussed in terms of CIP and HART protocols, similar methods may be performed using any protocol utilized by devices of an industrial network. CIP and HART are examples of suitable protocols.

At step 401, a controller may identify a HART command. For example, the controller may be a PLC executing software for controlling an industrial process or automation process. Execution of the software may cause a need for particular HART data from one of the field devices (e.g., identify a read command for particular HART data) or may cause a need for particular HART data values to be written to one of the field devices (e.g., identify a write command to particular HART data). Additionally, input entered by a user of the controller may cause a need to send particular read or write HART commands to a field device. Continuing the above example, the software or user input may cause a need to read or write a field device's manufacturer's ID number or product code, version, tag name, or other variable, and the corresponding read or write HART command may be identified. While the identified HART command may be dependent on which specification of the HART protocol the communication conforms to, in one or more instances, a HART command for reading a field device's manufacturer's ID number or product code may be HART command #0, and, as a second example, a HART command for writing a field device's tag may be HART command #18.

At step 403, the controller may create the HART command. In some embodiments, creating the HART command may include creating a complete data structure for a HART packet. For example, a HART packet that includes the data needed for the HART command identified at step 401 may be created by the controller. The HART packet that is created by the controller may include, for example, a preamble field, a start byte field, an address field, a command field, a number of data bytes field, a data field, and a checksum field. In other arrangements, only some of the data fields of a HART packet may be created by the controller. For example, the controller may create all data fields of the HART packet except for the preamble and/or the checksum field.

At step 405, the controller may encapsulate the HART command in a CIP message intended to invoke a CIP object service. In some variations, a CIP object may be defined specifically to provide a service for HART tunneling/encapsulation. In some arrangements, the controller and the gateway may each include an instance of that CIP object. In others, the gateway device may include an instance of the CIP object, but the controller may not include an instance of the CIP object. This CIP object may be referred to as a HART Tunnel Object. When the HART Tunnel Object resides on devices such as the controller, it may be considered a proxy between the controller and a HART device. When the HART Tunnel Object resides on devices such as the gateway device (details of which will be discussed further below in connection with FIG. 4B), it may be considered an interface to the HART data resident on the gateway device and/or other HART data accessible to the gateway device (e.g., HART data on a field device accessible to the gateway device via a HART request). Thus, the controller may encapsulate the HART command in a CIP message intended to invoke the CIP service provided by the HART Tunnel Object of the gateway device.

In some embodiments, the controller may encapsulate the HART command into a CIP message similar to the illustration in FIG. 5. FIG. 5 illustrates an example data format that may be used for encapsulating HART commands and HART responses using CIP. As illustrated in FIG. 5, field 511 (with a length of 0-8 bits) may be for a service code and include a value that corresponds to (or is unique to) the HART tunneling service being provided by the HART Tunnel Object. Field 512 (with a length of 1 byte) may be for a class identifier and include a value that corresponds to the class identifier of the HART Tunnel Object. Field 513 (with a length of 1 byte) may be for an instance identifier and include a value that corresponds to the instance identifier of the HART Tunnel Object. Field 514 (variable length) may be for service data and may include data of the HART command (maximum of 255 bytes). For example, in some variations, field 514 may include at least two data fields, including a code field (e.g., length 1 byte) that has an integer value that corresponds to the command field of the HART command, and a field for the data of the HART command (e.g., variable length with a maximum of 255 bytes, and organized into an array of octets). In some arrangements, the data of the HART command may include the complete HART command, including checksum and preambles. However, in some variations, the checksum and/or preamble may not be included.

In some arrangements, the message that encapsulates the HART command may include additional data (not shown), such as a flag indicating that the message is a CIP request, an address field indicating the address of the gateway device (e.g., IP address or MAC address), and the like.

At step 407, the controller may transmit the CIP message to a gateway device. In response to receiving a CIP message that encapsulates a HART command, a gateway device may, for example, extract the HART command from the CIP message, execute the command and transmit one of various response types to the controller. FIG. 4B provides an example method for processing CIP messages and transmitting encapsulated HART responses using CIP. In some arrangements, other protocols instead of CIP may be used, including another object-oriented protocol. Additionally, other protocols instead of HART may be used, such as another protocol for communicating with a field device. Details of the example method of FIG. 4B will be discussed in connection with the example data formats of FIG. 5. Although the example method of FIG. 4B is discussed in terms of CIP and HART protocols, similar methods may be performed using any protocol utilized by devices of an industrial network. CIP and HART are examples of suitable protocols.

At step 411, the gateway device may receive a CIP message from the controller (e.g., a CIP message transmitted at step 407 of FIG. 4A). In some arrangements, receiving the CIP message may include identifying the CIP message as being directed to the HART Tunnel Object of the gateway device (e.g., by examining the class identifier and/or the instance identifier of the CIP message); examining the service code of the CIP message (e.g., to determine that it corresponds to a service code for the HART Tunnel Object of the gateway device); or otherwise identifying the CIP message as a message that encapsulates a HART command.

At step 413, the gateway device may extract the HART command from the CIP message. Additionally, the gateway device may add fields to the extracted data. For example, in variations where HART data included in the CIP message never includes a preamble and/or a checksum, the gateway device may add the preamble and/or checksum to the extracted HART command.

At step 415, the gateway device may transmit the HART command to one or more field devices. After transmission of the HART command, the gateway device may proceed to wait for the one or more field devices to respond to the HART command.

At step 417, the gateway device may determine (e.g., periodically or upon expiration of a timer) whether the HART data responsive to the HART command has been received from the one or more field devices (otherwise referred to as a HART response). If the HART data has been received, the method may proceed to step 419. However, if the HART data has not been received, the method may proceed to step 418.

At step 418, the gateway device may determine if particular timeout criteria are satisfied. If the criteria are satisfied, the gateway device may encapsulate and transmit a message that indicates a busy exception (e.g., a field device is busy) or that indicates a device is not present (e.g., a field device is not present or not working properly). For example, in some variations, there may be two timeout mechanisms. First, there may be a timer set to ensure the controller does not timeout waiting for a response from the gateway device. If this timer exceeds a threshold value, the busy exception may be sent. Second, there may be a timer set to wait for a response from a field device. If the response is not received from the field device prior to the timer exceeding a threshold value, an exception response indicating the device is not present may be sent. In some arrangements, the controller, upon receiving the busy exception may reset its own timer and may retransmit the HART command (e.g., in another CIP message). When the gateway device receives the retransmitted HART command, it may recognize the command as one that is currently being processed and continue to wait on the response from the field device(s). Upon receiving an exception response indicating the device is not present, the controller may perform various exception handling processes.

At step 419, the gateway device may encapsulate the HART response in a CIP message. In some instances, the HART response may include an ID number or product code of the field device, the tag parameter of the field device, a version of the field device, or other HART parameters, such as a status of a write command. Similar to the controller's encapsulation of a HART command, the gateway device may encapsulate the HART response into a CIP message. The CIP message that encapsulates the HART response may include fields similar to the example data format illustrated in FIG. 5 (e.g., with fields for a service code, class identifier, instance identifier, and service data). The HART response, or a portion of the HART response, may be included in the service data field of the CIP message (e.g., with or without preambles and/or checksum). For example, in some variations, the service data of the CIP message may include at least two data fields, including a code field (e.g., length 1 byte) that has an integer value that corresponds to the command field of the HART response, and a field for the data of the HART response (e.g., variable length with a maximum of 255 bytes, and organized into an array of octets). In some arrangements, the data of the HART response may include the complete HART response, including checksum and preambles. However, in some variations, the checksum and/or preamble may not be included. The CIP message may also include additional data (not shown), such as a flag indicating that the message is a CIP response, an address field indicating the address of the controller (e.g., IP address or MAC address), and the like.

At step 421, the gateway device may transmit the CIP message to the controller.

Some steps of FIG. 4B may be optional or not performed in some variations. For example, certain HART commands may be a request for HART data that is stored at the gateway device. In such instances, there may be no need to forward the HART command to a field device and, instead, the data may be accessed after step 413 and then the method may proceed directly to step 419, where the accessed HART data may be encapsulated.

In some instances, the controller may be waiting to receive encapsulated HART data that is responsive to a HART command it previously sent. FIG. 4C provides an example method for receiving encapsulated HART responses using CIP. In some arrangements, other protocols instead of CIP may be used, including another object-oriented protocol. Additionally, other protocols instead of HART may be used, such as another protocol for communicating with a field device. Details of the example method of FIG. 4C will be discussed in connection with the example data formats of FIG. 5. Although the example method of FIG. 4C is discussed in terms of CIP and HART protocols, similar methods may be performed using any protocol utilized by devices of an industrial network. CIP and HART are examples of suitable protocols.

At step 431 of FIG. 4C, the controller may receive a CIP message that encapsulates a HART response from a gateway device (e.g., a CIP response transmitted at step 421 of FIG. 4B). In some arrangements, receiving the CIP message may include inspecting the CIP message and, for example, matching various fields included in the CIP message to the corresponding fields included in the message transmitted by the controller that encapsulated the HART command (e.g., by matching the class, attribute, service code, etc., of the CIP message to the corresponding fields of the message that encapsulated the HART command), or otherwise identifying the CIP message as a message that encapsulates a HART command.

At step 433, the controller may extract the HART response from the CIP message. At step 437, the controller may process the HART response. For example, the data of the HART response may be displayed for viewing by a user (e.g., display a requested ID number or product code of a field device), or the data may be stored for further processing by software executing on the controller (e.g., verify that the ID number or product code matches an expected value, analyze the status of the response to the write commend to ensure the write command was successful).

Various steps of FIGS. 4A, 4B and 4C may cause the controller or gateway device to transmit an exception handling message. Various conditions may cause the exception handling message to be transmitted. Accordingly, in addition to the steps illustrated in FIGS. 4A, 4B and 4C, the controller or gateway device may determine whether the HART command is an invalid length. If the HART command is an invalid length, the controller or gateway device may transmit a message with a CIP General Error Code. For example, if a HART command is less than five bytes in length or greater than 255 bytes in length, a message including a CIP General Error Code (e.g., 0x20 for an invalid parameter) may be transmitted.

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, one of ordinary skill in the art will appreciate that the steps described above may be performed in other than the recited order, including concurrently, and that one or more steps may be optional in accordance with aspects of the disclosure. It will also be appreciated and understood that modifications may be made without departing from the true spirit and scope of the present disclosure. The description is thus to be regarded as illustrative instead of restrictive on the present disclosure.

What is claimed is:

1. An apparatus comprising:
one or more processors; and
memory storing executable instructions configured to, when executed by the one or more processors, cause the apparatus to:
receive, from a computing device, a first message conforming to an object-oriented protocol that encapsulates a command that conforms to a protocol for communicating with one or more field devices;
extract the command from the first message;
transmit the command to the one or more field devices;
receive data responsive to the command from the one or more field devices;
encapsulate the data in a second message conforming to the object-oriented protocol; and
transmit the second message to the computing device.

2. The apparatus of claim 1, wherein the object-oriented protocol is Common Industrial Protocol (CIP) and the protocol for communicating with one or more field devices is a Highway Addressable Remote Transducer (HART) protocol.

3. The apparatus of claim 2, wherein the command requests an ID number or product code of a field device, a tag parameter of a field device, or version of a field device, and wherein the data responsive to the command includes the ID number or product code of a field device, the tag parameter of a field device, or the version of a field device.

4. The apparatus of claim 2, wherein the command writes a scaling factor or a limit value to a field device.

5. The apparatus of claim 2, wherein the first message includes a service code corresponding to a HART tunneling service provided by a CIP object.

6. The apparatus of claim 5, wherein the first message includes at least one of the following: a class identifier that identifies a class of the CIP object and an instance identifier that identifies an instance of the CIP object.

7. The apparatus of claim 5, wherein the first message includes a portion reserved for service data, wherein the portion reserved for service data includes the command.

8. The apparatus of claim 1, wherein the memory further stores executable instructions configured to, when executed by the one or more processors, cause the apparatus to:
determine that the command is an invalid length; and
transmit a message including an error code responsive to determining that the command is an invalid length.

9. A method comprising:
receiving, at a gateway device and from a computing device, a first message conforming to an object-oriented protocol that encapsulates a command that conforms to a protocol for communicating with one or more field devices;
extracting the command from the first message;
transmitting the command from the gateway device to the one or more field devices;
receiving, at the gateway device, data responsive to the command from the one or more field devices;
encapsulating the data in a second message conforming to the object-oriented protocol; and
transmitting the second message from the gateway device to the computing device.

10. The method of claim 9, wherein the gateway device is a multiplexer of an industrial network, and the computing device is a controller of the industrial network.

11. The method of claim 9, wherein the object-oriented protocol is Common Industrial Protocol (CIP) and the protocol for communicating with one or more field devices is a Highway Addressable Remote Transducer (HART) protocol.

12. The method of claim 11, wherein the command requests an ID number or product code of a field device, a tag parameter of a field device, or version of a field device, and wherein the data includes the ID number or product code of a field device, the tag parameter of a field device, or the version of a field device.

13. The method of claim 11, wherein the first message includes a service code corresponding to a HART tunneling service provided by a CIP object.

14. The method of claim 11, wherein first message includes at least one of the following: a class identifier that identifies a class of the CIP object and an instance identifier that identifies an instance of the CIP object.

15. The method of claim 11, wherein the first message includes a portion reserved for service data, wherein the portion reserved for service data includes the HART command.

16. A system comprising:
a controller of an industrial network;
a gateway device of the industrial network; and
one or more field devices of the industrial network;
wherein the gateway device is configured to:
receive, from the controller, a first message conforming to an object-oriented protocol that encapsulates a command conforming to a protocol for communicating with the one or more field devices;
extract the command from the first message;
transmit the command to the one or more field devices;
receive data responsive to the command from the one or more field devices;
encapsulate the data in a second message conforming to the object-oriented protocol; and
transmit the second message to the controller.

17. The system of claim 16, wherein the controller includes a programmable logic controller (PLC), and the gateway device includes a multiplexer.

18. The system of claim 16, wherein the controller is configured to:
create the command that requests an ID number or product code from the one or more field devices;
encapsulate the command in the first message;
transmit the first message to the gateway device;
receive the second message from the gateway device; and
extract the data from the second message, wherein the data includes the ID number or product code; and
verify that the ID number or product code matches an expected value.

19. The system of claim 16, wherein the object-oriented protocol is Common Industrial Protocol (CIP) and the protocol for communicating with one or more field devices is a Highway Addressable Remote Transducer (HART) protocol.

20. The system of claim 19, wherein first message includes at least one of the following: a service code corresponding to a HART tunneling service provided by a CIP object, a class identifier that identifies a class of the CIP object, or an instance identifier that identifies an instance of the CIP object.
